(19) United States
(12) Patent Application Publication
(10) Pub. No.: US 2026/0273470 A1
(43) Pub. Date: Sep. 17, 2026

(54) ELECTROCHEMICAL SYSTEM FOR GENERATING ACIDIC AND BASIC SOLUTIONS

(71) Applicant: The Board of Trustees of the Leland Stanford Junior University, Stanford, CA (US)

(72) Inventors: Matthew W. KANAN, Palo Alto, CA (US); Rishi Gupta AGARWAL, Menlo Park, CA (US); Benjamin P. CHARNAY, Palo Alto, CA (US); J. Gage WRIGHT, Menlo Park, CA (US); Jason W. MISLEH, Stanford, CA (US)

(21) Appl. No.: 19/480,199

(22) PCT Filed: May 8, 2024
(86) PCT No.: PCT/US2024/028374

§ 371 Date: Oct. 30, 2025

Related U.S. Application Data
(60) Provisional application No. 63/501,232, filed on May 10, 2023.

(51) Int. Cl. B01D 61/44; B01D 61/46; C02F 1/461

(52) U.S. Cl. CPC B01D 61/445; B01D 61/465; B01D 61/466; B01D 61/468; C02F 1/4618; B01D 2313/345

(57) ABSTRACT

An apparatus for producing acid and base solutions from salt solutions is provided. An anode and a cathode are provided. A bipolar component is between the anode and the cathode. A first separator is between the bipolar component and the anode. A second separator is between the bipolar component and the cathode. A first salt solution flow passage is between the anode and the first separator. A second salt solution flow passage is between the first separator and the bipolar component. A third salt solution flow passage is between the bipolar component and the second separator. A fourth salt solution flow passage is between the second separator and the cathode.

### CROSS REFERENCE TO RELATED APPLICATIONS

This application claims priority under 35 U.S.C. § 119 from U.S. Application No. 63/501,232, filed May 10, 2023, entitled GENERATION OF A PH OR ION GRADIENT USING A BIPOLAR GAS DIFFUSION ELECTRODE, by Kanan et al., which is incorporated herein by reference for all purposes.

### GOVERNMENT RIGHTS

This invention was made with Government support under contract U.S. Department of Energy (DE-SC0021633). The Government has certain rights in the invention.

### BACKGROUND

The background description provided here is for the purpose of generally presenting the context of the disclosure. Information described in this background section, as well as aspects of the description that may not otherwise qualify as prior art at the time of filing, are neither expressly nor impliedly admitted as prior art against the present disclosure.

This invention relates to the electrochemical production of acidic and basic solutions from a salt solution.

### SUMMARY

To achieve the foregoing and in accordance with the purpose of the present disclosure, an apparatus for producing acid and base solutions from salt solutions is provided. An anode and a cathode are provided. A bipolar component is between the anode and the cathode. A first separator is between the bipolar component and the anode. A second separator is between the bipolar component and the cathode. A first salt solution flow passage is between the anode and the first separator on a first side of the first separator. A second salt solution flow passage is on a second side of the first separator opposite the first side of the first separator, wherein the second salt solution flow passage is between the first separator and the bipolar component on a first side of the bipolar component. A third salt solution flow passage is on a second side of the bipolar component between the bipolar component and the second separator, wherein the third salt solution flow passage is on a first side of the second separator. A fourth salt solution flow passage is on a second side of the second separator opposite the first side of the second separator, wherein the fourth salt solution is between the second separator and the cathode.

In another manifestation, a method for producing acidic and basic solutions from salt solutions is provided. An anode is spaced apart from a cathode. A bipolar component is between the anode and the cathode. A first separator is between the bipolar component and the anode. A second separator is between the bipolar component and the cathode. A first salt solution is flowed between the first separator and the anode on a first side of the first separator. A second salt solution is flowed on a second side of the first separator opposite the first side of the first separator and between the first separator and the bipolar component. A third salt solution is flowed on a second side of the bipolar component between the bipolar component and the second separator, wherein the third salt solution flow is on a first side of the second separator. A fourth salt solution is flowed on a second side of the second separator opposite the first side of the second separator, wherein the fourth salt solution is between the second separator and the cathode. A voltage is applied between the anode and cathode causing a release of H⁺ into the first salt solution and the third salt solution and the release of OH⁻ into the second salt solution and the fourth salt solution.

In another manifestation, a bipolar gas diffusion electrode is provided. A first catalyst layer and a second catalyst layer are provided with a gas diffusion layer between the first catalyst layer and the second catalyst layer. An electrically conductive path is connected between the first catalyst layer and the second catalyst layer.

These and other features of the present invention will be described in more detail below in the detailed description of the disclosure and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIGS. 1A-B are schematic illustrations of electrochemical stacks used in some embodiments.

FIGS. 2A-D are schematic illustrations of bipolar components used in some embodiments.

FIGS. 3A-B are schematic illustrations of bipolar gas diffusion electrodes used in some embodiments.

FIG. 4A is a schematic illustration of a single cell with a diaphragm separator without a bipolar component used in the prior art.

FIG. 4B is a graph of a voltage versus time trace for the single cell in FIG. 4A.

FIG. 5 is a graph of voltage versus time trace for an embodiment.

In the drawings, like reference numerals are sometimes used to designate like structural elements. It should also be appreciated that the depictions in the figures are diagrammatic and not to scale.

### DETAILED DESCRIPTION OF ILLUSTRATED EMBODIMENTS

The electrochemical production of acidic and basic solutions from a salt solution (“electrochemical acid and base production”) has numerous existing and emerging applications for chemical and material manufacturing, mineral recovery, and carbon management. Many industrial processes consume stoichiometric acid (e.g., H₂SO₄) and base (e.g., NaOH) and produce a stoichiometric waste product (e.g., Na₂SO₄). Electrochemical acid and base production provides a potential way to replace such a linear process with a circular process wherein the acid and base are regenerated from a salt waste product using an electrical energy input. In addition, some processes that are performed thermally at high temperature could be performed by sequential application of acid and base at lower or ambient temperatures. For example, slaked lime (Ca(OH)₂) is produced by calcining limestone (CaCO₃) at high temperature (typically 700-900 °C) to form lime (CaO), followed by contacting the CaO with H₂O to form Ca(OH)₂. Alternatively, Ca(OH)₂ could be produced by contacting CaCO₃ with an aqueous acid solution to form an aqueous salt solution containing calcium ions and then contacting the aqueous salt solution containing calcium ions with an aqueous base solution to generate a Ca(OH)₂ precipitate and a salt solution depleted in calcium ions. By electrochemically regenerating the acid and base, such a process can be performed without stoichiometric acid and base consumption and waste byproduct production from acid and base consumption.

At present, the state-of-the-art technology for electrochemical acid and base production is bipolar membrane electrodialysis (BPMED). BPMED makes use of an electrochemical stack consisting of a repeating unit that contains an anion exchange membrane (AEM), a cation exchange membrane (CEM), and a bipolar membrane (BPM). BPMs are made by adhering a CEM to an AEM, with, optionally, a catalytic layer in between to assist in the dissociation of H₂O. BPMED can be used to generate relatively pure and concentrated (up to ~2 M) acid and base solutions from a salt solution input and has been used for many years in specialty chemical applications. However, BPMED has drawbacks that limit its use for acid and base production in other applications. One major drawback is that each cell in a BPMED has a large ohmic resistance resulting from the combination of the resistances of the three membranes and three solution layers in each cell. As a result, BPMED systems have large energy demands and low energy efficiency to produce acid and base at modest current densities. The large energy demand of BPMED systems results in high operating costs and may result in high process emissions depending on the emissions intensity of electricity generation. The low current densities result in high capital expense because very large electrode and membrane areas are required to generate useful quantities of acid and base per unit time.

Because BPMED systems rely on ion exchange membranes (CEM and AEM) to control ion flow, they are susceptible to membrane fouling and degradation processes, which typically are caused by impurities in the salt solution. Polyvalent cations (e.g., Ca²⁺, Mg²⁺) exchange with monovalent cations in the CEM, leading to increased resistance of the CEM the formation of metal hydroxide precipitates (e.g. Ca(OH)₂, Mg(OH)₂) that can damage the ion channels. As such, BPMED systems often have stringent requirements for scrubbing polyvalent cations from the input salt solution, which imposes additional costs and chemical consumption. This limitation is especially problematic for applications of electrochemical acid and base production in which the acid and base solutions are used to perform chemistry on a material with a high content of polyvalent cations.

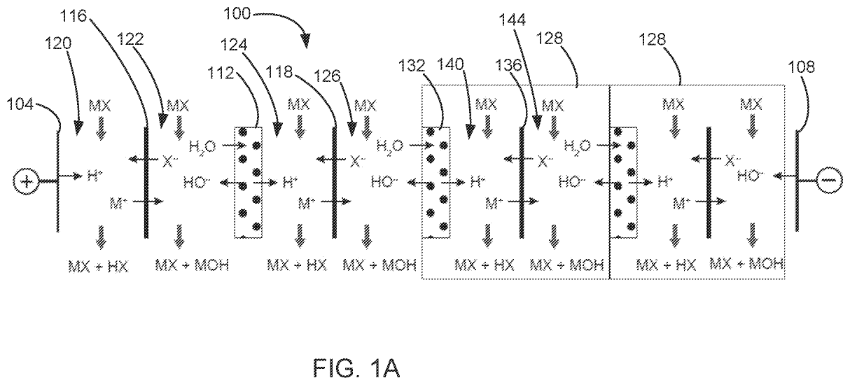

Disclosed is a device and a method for electrochemical production of acid and base from a salt solution that circumvents the drawbacks of BPMED. FIG. 1A is a schematic illustration of an embodiment of an electrochemical stack 100. The electrochemical stack 100 comprises a terminal anode 104, a terminal cathode 108, a bipolar component 112, and a first separator 116, a second separator 118, a first salt solution flow passage 120 is between the first separator 116 and the terminal anode 104 on a first side of the first separator 116, a second salt solution flow passage 122 is on a second side of the first separator 116 opposite the first side of the first separator, a third salt solution flow passage 124 is between the second separator 118 and the bipolar component 112 on the first side of the second separator 118 and a second side of the bipolar component 112, a fourth salt solution flow passage 126 between the second separator 118 and the terminal cathode 108, and one or more repeating units 128, where each repeating unit 128 comprises a repeating unit bipolar component 132, a repeating unit separator 136 between the repeating bipolar component 132 and the terminal cathode 108, a first repeating unit salt solution flow passage 140 between the repeating unit separator 136 and the repeating unit bipolar component 132 on a first side of the repeating unit separator 136, and a second repeating unit salt solution flow passage 144 on a second side of the repeating unit separator 136 opposite the first side of the repeating unit separator 136. The repeating unit may be repeated n times, where n is a whole number greater than zero. The fourth salt solution flow passage 126 being between the second separator 118 and the terminal cathode 108 means that the fourth salt solution flow passage 126 is on the second side of the second separator 118 that faces the terminal cathode 108 and does not necessarily mean that the fourth salt solution flow passage 126 is adjacent to the terminal cathode 108. In the embodiment shown in FIG. 1A, the fourth salt solution flow passage 126 is not adjacent to the terminal cathode 108. Instead, two repeating units 128 are between the fourth salt solution flow passage 126 and the terminal cathode 108.

When voltage is applied across the terminal anode 104 and terminal cathode 108, the bipolar component generates 112 a proton (H⁺) that is released into the third salt solution flow passage 124 on the second side of the bipolar component 112 facing the terminal cathode 108. A hydroxide (OH⁻) is released into the second salt solution flow passage 122 on the first side of the bipolar component 112 facing the terminal anode 104.

FIG. 1B is a schematic illustration of an embodiment of a two-cell electrochemical stack 150. The two-cell electrochemical stack 150 is an embodiment of the electrochemical stack 100, shown in FIG. 1A, where there are no repeating units. The two-cell electrochemical stack 150 comprises a terminal anode 154, a terminal cathode 158, a bipolar component 162, and a first separator 166, a second separator 182, a first salt solution flow passage 170 between the first separator 166, and the terminal anode 154 on a first side of the first separator 166, a second salt solution flow passage 174 is on a second side of the first separator 166 opposite the first side of the first separator between the first separator 166 and the bipolar component 162 on a first side of the bipolar component 162, a third salt solution flow passage 178 between the second separator 182 and the bipolar component 162 on the first side of the second separator 182 and a second side of the bipolar component 162, and a fourth salt solution flow passage 186 between the second separator 182 and the terminal cathode 158. In some embodiments, the first side of the bipolar component 162 is the terminal anode 154 facing side of the bipolar component 162. In some embodiments, OH⁻ is produced on the terminal anode 154 facing side of the bipolar component 162 and H⁺ is produced on the terminal cathode 158 side of the bipolar component 162, which is the second side of the bipolar component 162. In some embodiments, a power source 194, such as a battery, is connected to provide a voltage between the anode 154 and the cathode 158.

When voltage is applied across the terminal anode 154 and terminal cathode 158, the bipolar component generates 162 a proton (H⁺) that is released into the third salt solution flow passage 178 on the second side of the bipolar component 162 facing the terminal cathode 158. A hydroxide (OH⁻) is released into the second salt solution flow passage 174 on the first side of the bipolar component 162 facing the terminal anode 154. In addition, salt anions migrate through the first separator 166 to the first salt solution flow passage 170, salt anions migrate through the second separator 182 to the third salt solution flow passage 178, salt cations migrate through the first separator 166 to the second salt solution flow passage 174, and salt cations migrate through the second separator 182 to the fourth salt solution flow passage 186.

In other embodiments, the device contains at least 5 repeating units. In other embodiments, the device contains at least 10 repeating units. In other embodiments, the device contains at least 20 repeating units. In other embodiments, the device contains at least 50 repeating units.

In some embodiments, the bipolar component is a bipolar membrane (BPM).

In some embodiments, the bipolar component comprises two gas diffusion electrodes (GDEs). In some embodiments, the GDEs that comprise the bipolar component are comprised of a catalyst layer on a gas diffusion layer (GDL). The catalyst layers may be comprised of Pt, Ni, PtNi, PtRu, MoNi₄, Ir, IrO₂, carbon blacks, polytetrafluoroethylene (PTFE), cationic ionomer, or anionic ionomer. In some embodiments, the catalyst layer on one GDE of the bipolar component causes a hydrogen evolution reaction, and the catalyst layer on the second GDE of the bipolar component causes a hydrogen oxidation reaction. In some embodiments, the catalyst layer on one GDE of the bipolar component causes an oxygen evolution reaction, and the catalyst layer on the second GDE of the bipolar component causes an oxygen reduction reaction. In some embodiments, the GDL comprises one or more layers of porous carbon materials. In some embodiments, the GDL comprises a macroporous carbon layer and a microporous carbon layer. In some embodiments, the GDL is treated with PTFE or other hydrophobic substances to control the wetting properties. In some embodiments, the gas GDL is electrically conductive.

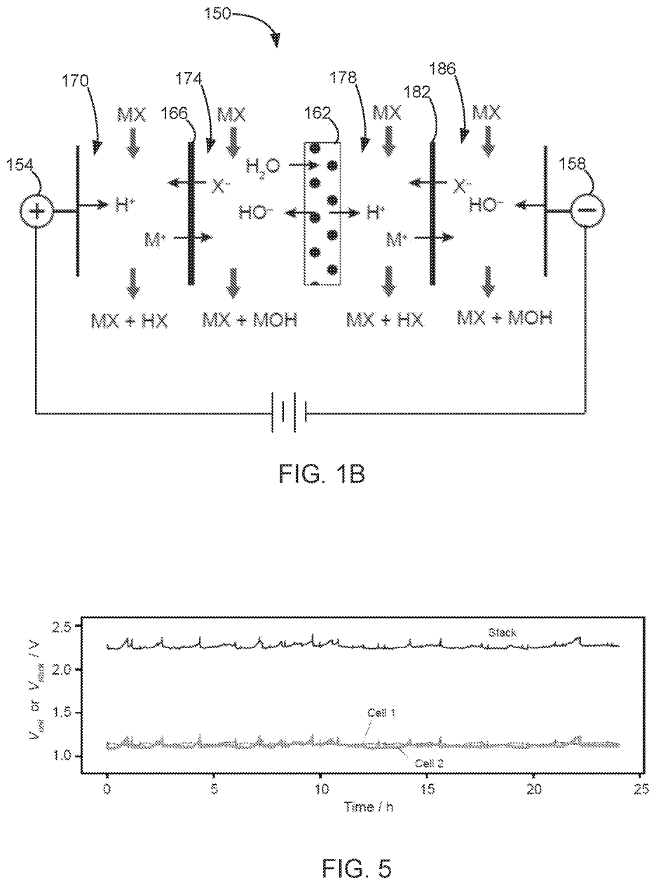

FIG. 2A is a schematic illustration of a bipolar component 200 that may be used in some embodiments. The bipolar component 200 comprises a first gas diffusion electrode (GDE) 204, a bipolar plate 208 where the first GDE 204 is on a first side of the bipolar plate 208, and a second GDE 212 on a second side of the bipolar plate 208. The first GDE 204 is electrically connected to the second GDE 212 by an electrically conductive path through the bipolar plate 208. In some embodiments, there is a transport path 214 around the bipolar plate 208 by which gas can flow from one GDE on one side of the bipolar plate 208 to the other GDE on the other side. A first salt solution 220 is flowed on a side of the first GDE 204. A second salt solution 224 is flowed on a side of the second GDE 212. The first GDE 204 and the second GDE 212 are each in contact with a flow field 201a, 201b for gas transport.

FIG. 2B is a schematic illustration of a bipolar component 200 that may be used in some embodiments. The bipolar component 200 comprises a first GDE 204, a bipolar plate 208 where the first GDE 204 is on a first side of the bipolar plate 208, and a second GDE 212 on a second side of the bipolar plate 208. Perforations or holes 216 are in the bipolar plate 208 through which gas can flow providing a transport path for the gas. A first salt solution 220 is flowed on a side of the first GDE 204. A second salt solution 224 is flowed on a side of the second GDE 212. In some embodiments of the bipolar component 200, one GDE in contact with an aqueous salt solution reduces water to hydrogen (H₂) and OH⁻. The H₂ is then transported to the other GDE of the bipolar component that is in contact with a second salt solution, where the H₂ is oxidized to form H⁺ in the second salt solution, as shown in FIGS. 2A and 2B. In this way, the net process converts H₂O into separated streams of H⁺ and OH⁻. In some embodiments, at least 99% of the H₂ that is oxidized at the second GDE 212 is produced at the first GDE 204. In another embodiment of the bipolar component, one GDE oxidizes H₂O to O₂ gas and H⁺. The O₂ is then transported to the other GDE in contact with a second electrolyte, where the O₂ is reduced to form OH⁻ in the second electrolyte. The net process converts H₂O into separated streams of H⁺ and OH⁻.

FIG. 2C is a schematic illustration of a bipolar component 200 that may be used in some embodiments. The bipolar component 200 comprises a first gas diffusion electrode (GDE) 204, an electrically insulating layer 209 where the first GDE 204 is on a first side of the electrically insulating layer 209, and a second GDE 212 on a second side of the electrically insulating layer 209. In some embodiments, the electrically insulating layer 209 is macroporous, mesoporous, or microporous to allow gas transport. In some embodiments perforations or holes are in the electrically insulating layer 209 through which gas can flow. A first salt solution 220 is flowed on a side of the first GDE 204. A second salt solution 224 is flowed on a side of the second GDE 212. In FIG. 2C, the electrically insulating layer 209 is an electrical insulator so that electrons do not flow through the electrically insulating layer 209. Instead, an external electrical conductor between the first GDE 204 and the second GDE 212 provides an electrically conductive path 232 that allows electrons to flow from the second GDE 212 to the first GDE 204.

FIG. 2D is a schematic illustration of a bipolar component 200 that may be used in some embodiments. The bipolar component 200 comprises a first gas diffusion electrode (GDE) 204, a bipolar plate 208 where the first GDE 204 is on a first side of the bipolar plate 208, and a second GDE 212 on a second side of the bipolar plate 208. A first salt solution 220 is flowed on a side of the first GDE 204. A second salt solution 224 is flowed on a side of the second GDE 212. In FIG. 2D, there is no flow of H₂ around or through the bipolar plate 208. Instead, H₂ generated by the first GDE 204 is collected in a H₂ gas collector 236, and H₂ is provided from a H₂ gas supply 240 to the second GDE 212. In some embodiments, the amount of H₂ collected by the H₂ gas collector 236 is at least 99% of the amount of He supplied by the H₂ gas supply 240.

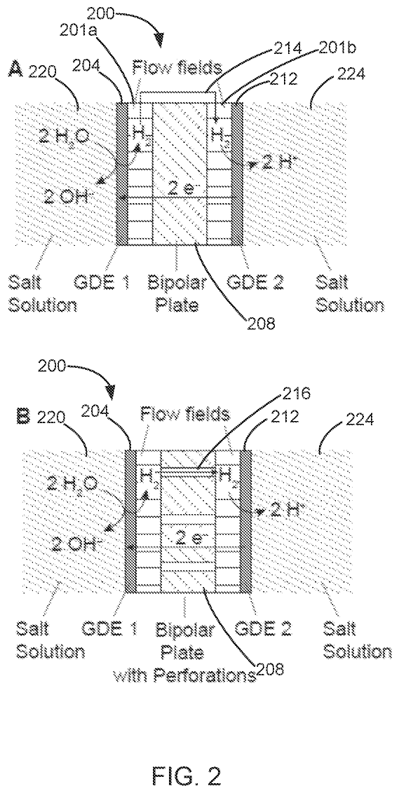

In some embodiments, the bipolar component is a bipolar gas diffusion electrode (BPGDE). FIG. 3A is a schematic illustration of a BPGDE 300 comprising a first catalyst layer 304, a second catalyst layer 308, and a gas diffusion layer 312 between the first catalyst layer 304 and the second catalyst layer 308. The first and second catalyst layers 304, 308 are connected by an electrically conductive path, which may be the gas diffusion layer itself. When polarized, one catalyst layer on the BPGDE 300 generates a gaseous product that is transported to the other layer where it is oxidized. In some embodiments, the catalyst layers may be comprised of Pt, Ni, PtNi, PtRu, MoNi₄, Ir, IrO₂, carbon blacks, polytetrafluoroethylene (PTFE), cationic ionomer, or anionic ionomer. In some embodiments, the gas diffusion layer 312 comprises one or more layers of porous carbon materials. In some embodiments, the gas diffusion layer 312 comprises a macroporous carbon layer and a microporous carbon layer. In some embodiments, the gas diffusion layer 312 is treated with PTFE or other hydrophobic substances to control the wetting properties. In some embodiments, the gas diffusion layer 312 is electrically conductive. In some embodiments, the gas diffusion layer comprises one or more layers of porous metals.

In some embodiments of the BPGDE 300, the first catalyst layer 304 is in contact with a first aqueous electrolyte 316 and reduces water to hydrogen (H₂) and OH⁻, as shown in FIG. 3A. Therefore, the first catalyst layer 304 causes a hydrogen evolution reaction. The H₂ is then transported through the GDL to the second catalyst layer 308 in contact with a second aqueous electrolyte 320, where the H₂ is oxidized to form H⁺ in the second aqueous electrolyte 320. Therefore, the second catalyst layer 308 causes a hydrogen oxidation reaction. In this way, the net process converts H₂O into separated streams of H⁺ and OH⁻. In some embodiments, the aqueous electrolyte 316 may have additional solvents in addition to water.

FIG. 3B is a schematic illustration of another embodiment of the BPGDE 340, comprising a first catalyst layer 344, a second catalyst layer 348, and a gas diffusion layer 352 between the first catalyst layer 344 and the second catalyst layer 348. The first catalyst layer 344 is in contact with a first aqueous electrolyte 356 and oxidizes H₂O to O₂ gas and H⁺. Therefore, the first catalyst layer 344 causes an oxygen evolution reaction. The O₂ is then transported through the gas diffusion layer 352 to the second catalyst layer 348 in contact with a second aqueous electrolyte 360, where the O₂ is reduced to form OH⁻ in the second aqueous electrolyte 360. Therefore, the second catalyst layer 348 causes an oxygen reduction reaction. The net process converts H₂O into separated streams of H⁺ and OH⁻.

With a BPM, it is possible for ion crossover to occur because the CEM and AEM components are not perfectly selective for cations and anions, respectively. With a bipolar component comprised of two GDEs, an electrically conductive path, and a gas transporting path, such as the embodiments illustrated in FIGS. 2A-D, ion crossover is blocked because there is not an ion-conductive path from one side to the other. Similarly, with a BPGDE, wherein the catalyst layers are separated by a hydrophobic GDL, ion crossover is blocked because there is not an ion-conductive path from one side to the other.

In some embodiments of the device, one or more of the separators is a porous diaphragm separator. In some embodiments, one or more of the separators is a Zirfon® hydrogen separator membrane composed of a polysulfone matrix and zirconia (ZrO₂). In some embodiments, one or more of the separators is a microporous separator, such as Fumasep® FAAM manufactured by Fumatech. In other embodiments, one or more of the separators is a CEM. In other embodiments, one or more of the separators is an AEM. The use of a diaphragm separator instead of a CEM or AEM is a preferred embodiment because diaphragm separators have lower ionic resistivity and greater tolerance to impurities in the salt solution.

In some embodiments, an input salt is divided into multiple streams that are flowed between the separators and the bipolar components while a voltage is applied across the terminal electrodes. In some embodiments, an input salt is divided into multiple streams that are flowed between the separators and the bipolar components while a current is applied across the terminal electrodes. The bipolar components release H⁺ ions into the salt solution at the second side of the bipolar component facing the cathode and release OH⁻ ions into the salt solution at the first side facing the anode while ions in the salt solutions are transported across the separators. In some embodiments, all of the salt solutions streams to which H⁺ have been added are combined into a single output acid stream and all the salt solutions to which OH⁻ have been added are combined into a single output base stream. Thus, the stack inputs a salt solution and outputs two salt solutions, one that is acidic and one that is basic. In some embodiments, at least two of the salt solution streams to which H⁺ has been added are connected in series. In some embodiments, at least two of the salt solution streams to which H⁺ has been added are connected in parallel. In some embodiments, at least two of the salt solution streams to which OH⁻ has been added are connected in series. In some embodiments, at least two of the salt solution streams to which OH⁻ has been added are connected in parallel. In some embodiments, all the salt solution streams to which H⁺ has been added are connected in series. In some embodiments, all the salt solution streams to which H⁺ has been added are connected in parallel. In some embodiments, all the salt solution streams to which OH⁻ has been added are connected in series. In some embodiments, all the salt solution streams to which OH⁻ has been added are connected in parallel.

In some embodiments, the salt solutions contain a high concentration of salt such that a substantial portion of the ionic current is carried by the ions comprising the salt instead of H⁺ and/or OH⁻. The current efficiency of the system is the fraction of the total current that results in separated OH⁻ and H⁺. Using a high salt concentration can improve the current efficiency by providing a high concentration of salt cations and salt anions to carry the ionic current, thereby avoiding H⁺/OH⁻ recombination.

In some embodiments, the salt solutions are aqueous salt solutions. In other embodiments, the salt solutions contain a mixture of both water and one or more organic solvents. In some embodiments, the salt solutions contain methanol, ethanol, propanol, butanol, acetonitrile, dimethylsulfoxide, or dimethylformamide.

In some embodiments, the electrochemical reaction at the terminal anode releases H⁺ into a salt solution in contact with the terminal anode, and the electrochemical reaction at the terminal cathode releases OH⁻ into a salt solution in contact with the terminal cathode, as shown in FIG. 1B. In some embodiments, the electrochemical reaction at the terminal anode oxidizes a redox active molecule or ion and the electrochemical reaction at the terminal cathode reduces a redox active molecule or ion.

In some embodiments, the input salt solution contains a Brønsted base whose conjugate acid has a pKₐ higher than H₃O⁺ but still low enough to be a useful acid. As such, this anion can accept the H⁺ generated at the cathode-facing side of the bipolar component and thereby suppress the formation of H₃O⁺, which serves to improve the current efficiency. In some embodiments, the electrolyte contains SO₄²⁻, PO₄³⁻, HPO₄²⁻, H₂PO₄⁻, RPO₃²⁻, RPO₂(OH)⁻, or RCO₂⁻, where R═H, alkyl, vinyl, aryl, or heteroaryl group.

In some embodiments, the input salt solution contains a Brønsted acid whose pKₐ is lower than H₂O but still high enough for the conjugate base to be a useful Brønsted base. As such, this Brønsted acid can neutralize the OH⁻ generated at the anode-facing side of the bipolar component and thereby suppress the formation of OH⁻, which serves to improve the current efficiency. In some embodiments, the electrolyte contains an ammonium ion, e.g., NH₄⁺, RNH₃⁺, R₂NH₂⁺, or R₃NH⁺, or an amidinium ion RCN₂H₂⁺, where R═H, alkyl, vinyl, aryl, or heteroaryl group.

### Experiments

Experiment 1: Electrochemical Acid and Base Production in a Single Cell with a Diaphragm Separator Without a Bipolar Component

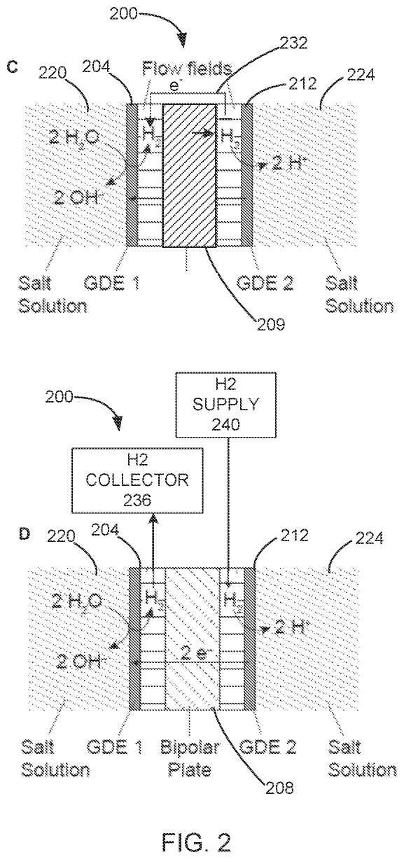

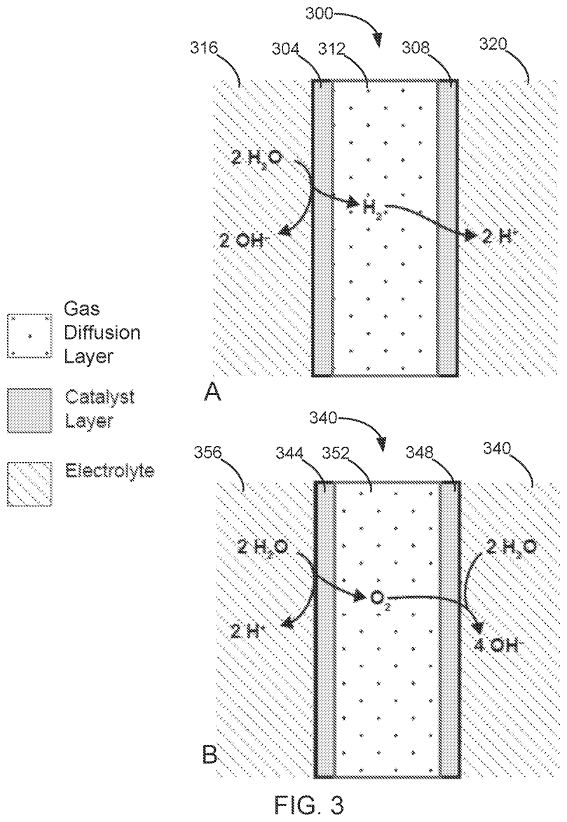

FIG. 4A is a schematic illustration of a single cell with a diaphragm separator without a bipolar component used in Experiment 1 to provide a prior art comparison. A single cell is provided comprising a terminal anode 404, a terminal cathode 408, and a porous diaphragm separator 412. A cell was assembled using two machined Grade V Ti blocks that deliver H₂ and electrolyte, a series of 10 thousandths of an inch thick silicone gaskets, and a diaphragm separator of Zirfon®. Two electrode assemblies were constructed, each composed of a GDE with a catalyst layer, a gasket that defines the pocket in which the GDE sits, a gasket that defines the active electrode area and seals the GDE edges from electrolyte, a gasket that defines the solution path across the GDE, and a final gasket to close the solution compartment and flow path. As defined by the gaskets, the solution compartments define a first salt solution flow passage 420 for the anolyte between the porous diaphragm separator 412 and the terminal anode 404 and a second salt solution flow passage 416 for the catholyte between the porous diaphragm separator 412 and the terminal cathode 408. The solution flow passages are 375 μm thick and the active electrode areas are 1 cm².

For the anode assembly, the catalyst layer contained Pt nanoparticles; for the cathode assembly, the catalyst layer contained PtNi nanoparticles. The two electrode assemblies were separated by a piece of Zirfon® and accompanying gaskets. The final full cell assembly was compressed in a vise to seal the gaskets. Production of acid and base was performed by flowing two streams of the same salt solution at rates of 0.1 mL min⁻¹ through both the catholyte and anolyte compartments while simultaneously applying a fixed current density of 100 mA cm⁻² and flowing H₂ across both electrodes at a rate of 1.5 standard cubic centimeters per minute (sccm). The salt solution was composed of an aqueous solution of 3 M NaCl and 0.75 M Na₂SO₄ with approximately 300 μM each of Mg and Si impurities as quantified by ICP-OES. The cell was operated using a duty cycle wherein the cell was operated in reverse polarity at the same fixed current density (100 mA cm⁻²) for 60 seconds(s) every 5 hours (h). The net current passed is 99.7% of that which would have been passed over the same time span without the reverse polarization duty cycle. The voltage vs time trace is shown in FIG. 4B. The cell exhibited a steady-state voltage of approximately 1.04 V with an average voltage increase of 1.6 mV h⁻¹±0.4 mV h⁻¹ over each 5 h step. The average voltage restoration after each reverse polarization was 6 mV±1 mV. The current efficiency measured by Mg(OH)₂ precipitation was 65%. Taking into account the current efficiency and steady-state voltage, the energy demand per mole of acid and base was calculated to be 0.043 kwh mol⁻¹. The output concentrations of acid and base were 0.4 M.

Experiment 2: Electrochemical Acid and Base Production in a 2-Cell Stack with a Bipolar Component

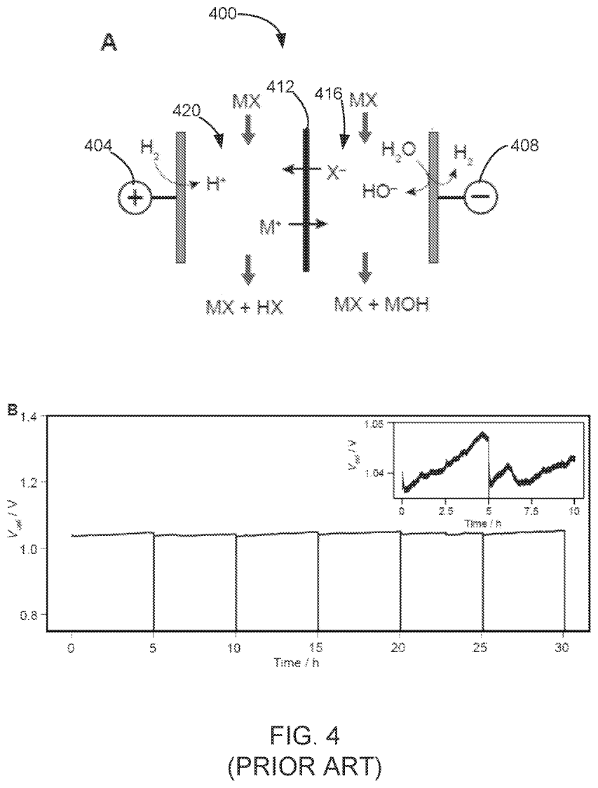

In Experiment 2, an electrochemical stack like the electrochemical stack 150, shown in FIG. 1B is used. This experiment evaluates acid and base production in a two-cell stack, such as electrochemical stack 150. The electrochemical stack 150 was assembled using a BPGDE as the bipolar component 162. The stack comprised a terminal anode 154 and terminal cathode 158 comprising blocks machined from Grade V Ti, a GDE with a catalyst layer containing Pt nanoparticles, and a GDE with a catalyst layer containing PtNi nanoparticles; four liquid 3D printed plastic plates with channels that defined the salt solution flow passages 170, 174, 178 and 186; a first separator 166 and second separator 182, both of which are Zirfon® separators; a BPGDE assembly, and various gaskets and O-rings to seal the stack. The bipolar component 162 comprised a BPGDE assembly made by sandwiching two GDEs with the catalyst layers facing outwards between two of the four 3D printed plastic plates with channels and openings to define the volume of salt solution passing over either side of the BPGDE. The anolyte consists of the first salt solution flowing through the first salt solution flow passage 170 and the third salt solution flow passage 178. The catholyte consists of the second salt solution flowing through the second salt solution flow passage 174 and the fourth salt solution flow passage 186. To assemble the stack, the components were combined as shown in FIG. 1B. A solution comprised of 3 M NaCl and 0.75 M Na₂SO₄ was flowed into the electrochemical stack 150 as both the anolyte and the catholyte, and H₂ was flowed across the terminal anode 154 and terminal cathode 158. Prior to stack operation, the BPGDE was pre-charged with H₂, and the atmosphere in the porous transport layer was displaced by running current through only the first cell, generating excess H₂ at the cathode side of the bipolar component 162. This was done at an applied potential of −1.3 V with the bipolar plate acting as a current collector for the cathode/working electrode for between 30 and 60 s. Following this pre-charging, the stack was run in reverse for 1 minute at 2.4 V. The stack was then operated galvanostatically at 100 mA cm⁻² for 48 h and the stack voltage was measured with the driving potentiostat. The catholyte and anolyte were both flowed at 0.1 mL min⁻¹ cm⁻². No excess H₂ was supplied to the BPGDE in this stack during the 48 h run. During stack operation, cell 2 was monitored with an open circuit potential measurement. FIG. 5 shows the voltage vs. time traces for the stack and the two component cells after an initial break-in period of 24 hours. The stack voltage maintained a quasi-steady state value of 2.25 V, and voltage spikes are attributed to concomitant bubble accumulation and release observed at the terminal electrodes. The CE was determined by Mg(OH)₂ precipitation to be 69% during both the break-in period and the quasi-steady-state period, which is comparable to the performance of a single cell. The ability of the BPGDE to operate with no external H₂ supply for 48 h indicates that at least 99.99% of the H₂ generated at the BPGDE's cathode is oxidized at the connected anode.

### Repeating Units

By providing n repeating units 128 in the electrochemical stack 100, as shown in FIG. 1A, the production of acid and base can be scaled up. In some embodiments, a separator may be absent between a salt solution flow passage and a terminal anode or terminal cathode.

While this invention has been described in terms of several preferred embodiments, there are alterations, permutations, modifications, and various substitute equivalents, which fall within the scope of this invention. It should also be noted that there are many alternative ways of implementing the methods and apparatuses of the present invention. It is therefore intended that the following appended claims be interpreted as including all such alterations, permutations, modifications, and various substitute equivalents as fall within the true spirit and scope of the present invention. As used herein, the phrase “A, B, or C” should be construed to mean a logical (“A OR B OR C”), using a non-exclusive logical “OR,” and should not be construed to mean ‘only one of A or B or C. Each step within a process may be an optional step and is not required. Different embodiments may have one or more steps removed or may provide steps in a different order. In addition, various embodiments may provide different steps simultaneously instead of sequentially.

What is claimed is:

1. An apparatus for producing acid and base solutions from salt solutions, comprising:
an anode;
a cathode;
a bipolar component between the anode and the cathode;
a first separator between the bipolar component and the anode;
a second separator between the bipolar component and the cathode;
a first salt solution flow passage between the anode and the first separator on a first side of the first separator;
a second salt solution flow passage on a second side of the first separator opposite the first side of the first separator, wherein the second salt solution flow passage is between the first separator and the bipolar component on a first side of the bipolar component;
a third salt solution flow passage on a second side of the bipolar component between the bipolar component and the second separator, wherein the third salt solution flow passage is on a first side of the second separator; and
a fourth salt solution flow passage on a second side of the second separator opposite the first side of the second separator, wherein the fourth salt solution is between the second separator and the cathode.

2. The apparatus, as recited in claim 1, further comprising at least one repeating unit between the anode and cathode, wherein each repeating unit comprises:
a repeating unit bipolar component;
a repeating unit separator between the repeating unit bipolar component and the cathode;
a first repeating unit salt solution flow passage between the repeating unit bipolar component and the repeating unit separator on a first side of the repeating unit separator; and
a second repeating unit salt solution flow passage on a second side of the repeating unit separator opposite the first side of the repeating unit separator.

3. The apparatus, as recited in claim 2, wherein an application of a voltage between the anode and cathode results in a release of H⁺ into the first salt solution flow passage, the third salt solution flow passage, and each first repeating unit salt solution flow passage and release of OH⁻ into the second salt solution flow passage, the fourth salt solution flow passage, and each second repeating unit salt solution flow passage.

4. The apparatus, as recited in claim 1, wherein an application of a voltage between the anode and cathode results in a release of H⁺ into the first salt solution flow passage and the third salt solution flow passage and the release of OH⁻ into the other of the second salt solution flow passage and fourth salt solution flow passage.

5. (canceled)

6. The apparatus, as recited in claim 1, wherein the bipolar component comprises a bipolar membrane.

7. The apparatus, as recited in claim 1, wherein the bipolar component comprises a bipolar gas diffusion electrode, comprising:
a first catalyst layer;
a second catalyst layer;
a gas diffusion layer between the first catalyst layer and second catalyst layer; and
an electrically conductive path connected between the first catalyst layer and the second catalyst layer.

8. The apparatus, as recited in claim 1, wherein the first separator comprises at least one of a diaphragm, a cation exchange membrane, and an anion exchange membrane.

9. (canceled)

10. The apparatus, as recited in claim 1, wherein the bipolar component comprises
a first gas diffusion electrode;
a second gas diffusion electrode;
an electrically conductive path between the first gas diffusion electrode and the second gas diffusion electrode; and
a transport path for transporting gas from the first gas diffusion electrode and transporting gas to the second gas diffusion electrode.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. A method for producing acid and base solutions from salt solutions, comprising:
providing an anode spaced apart from a cathode;
providing a bipolar component between the anode and the cathode;
providing a first separator between the bipolar component and the anode;
providing a second separator between the bipolar component and the cathode flowing a first salt solution between the first separator and the anode on a first side of the first separator; and
flowing a second salt solution on a second side of the first separator opposite the first side of the first separator and between the first separator and the bipolar component;
flowing a third salt solution on a second side of the bipolar component between the bipolar component and the second separator, wherein the third salt solution flow is on a first side of the second separator;
flowing a fourth salt solution on a second side of the second separator opposite the first side of the second separator, wherein the fourth salt solution is between the second separator and the cathode; and
applying a voltage between the anode and cathode causing a release of H⁺ into the first salt solution and the third salt solution and the release of OH⁻ into the second salt solution and the fourth salt solution.

23. The method, as recited in claim 22, further comprising:
providing at least one repeating unit between the anode and cathode, wherein each repeating unit comprises
a repeating unit bipolar component; and
a repeating unit separator between the repeating unit bipolar component and the cathode;
flowing a first repeating unit salt solution between the repeating unit bipolar component and the repeating unit separator on a first side of the repeating unit separator; and
flowing a second repeating unit salt solution on a second side of the repeating unit separator opposite the first side of the repeating unit separator.

24. The method, as recited in claim 22, wherein the applying a voltage between the anode and cathode results in a release of H⁺ into the first repeating unit salt solution and the release of OH⁻ into the second repeating unit salt solution.

25. The method, as recited in claim 22, wherein the bipolar component comprises a bipolar membrane.

26. The method, as recited in claim 22, wherein the bipolar component comprises a bipolar gas diffusion electrode, comprising:
a first catalyst layer;
a second catalyst layer;
a gas diffusion layer between the first catalyst layer and second catalyst layer; and
an electrically conductive path connected between the first catalyst layer and the second catalyst layer.

27. The method, as recited in claim 22, wherein the first separator comprises at least one of a diaphragm, a cation exchange membrane, and an anion exchange membrane.

28. The method, as recited in claim 22, wherein a salt solution provided for flowing the first salt solution is provided in series for flowing the third salt solution.

29. The method, as recited in claim 22, wherein the applying a voltage between the anode and cathode further results in salt anions migrating through the first separator to the first salt solution and salt anions migrating through the second separator to the third salt solution and salt cations migrating through the first separator to the second salt solution and salt cations migrating through the second separator to the fourth salt solution.

30. (canceled)

31. (canceled)

32. (canceled)

33. (canceled)

34. (canceled)

35. A bipolar gas diffusion electrode, comprising:
a first catalyst layer;
a second catalyst layer;
a gas diffusion layer between the first catalyst layer and second catalyst layer; and
an electrically conductive path connected between the first catalyst layer and the second catalyst layer.

36. The bipolar gas diffusion electrode, as recited in claim 35, wherein the gas diffusion layer is pre-charged with a gaseous product.

37. The bipolar gas diffusion electrode, as recited in claim 35, wherein the first catalyst layer causes a hydrogen evolution reaction and the second catalyst layer causes a hydrogen oxidation reaction.

38. The bipolar gas diffusion electrode, as recited in claim 35, wherein the first catalyst layer causes an oxygen evolution reaction and the second catalyst layer causes an oxygen reduction reaction.

39. (canceled)

40. (canceled)
